(19) United States
(12) Patent Application Publication
(10) Pub. No.: US 2019/0024439 A1
(43) Pub. Date: Jan. 24, 2019

(54) Gun Safe Assembly

(71) Applicant: Sam Guelli, Fall Branch, TN (US)

(72) Inventor: Sam Guelli, Fall Branch, TN (US)

(21) Appl. No.: 15/654,701

(22) Filed: Jul. 20, 2017

(51) Int. Cl. E05G 1/00; A47B 81/00

(52) U.S. Cl. CPC E05G 1/00; A47B 81/005

(57) ABSTRACT

A gun safe assembly for securing a rifle includes a base that may positioned on a support surface. A platform is positioned on the base and a butt of a rifle is selectively positioned on the platform having the rifle being vertically oriented. A first shell extends upwardly from the base and the first shell partially surrounds the rifle when the rifle is positioned on the platform. A second shell provided and the second shell is removably coupled to the base. The second shell abuts the first shell to surround the rifle when the second shell is positioned on the base. In this way the rifle is inhibited from being removed from the platform.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including Information Disclosed under 37 CFR 1.97 and 1.98

The disclosure and prior art relates to safe devices and more particularly pertains to a new safe device for securing a rifle.

### BRIEF SUMMARY OF THE INVENTION

An embodiment of the disclosure meets the needs presented above by generally comprising a base that may positioned on a support surface. A platform is positioned on the base and a butt of a rifle is selectively positioned on the platform having the rifle being vertically oriented. A first shell extends upwardly from the base and the first shell partially surrounds the rifle when the rifle is positioned on the platform. A second shell provided and the second shell is removably coupled to the base. The second shell abuts the first shell to surround the rifle when the second shell is positioned on the base. In this way the rifle is inhibited from being removed from the platform.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a gun safe assembly according to an embodiment of the disclosure.

FIG. 2 is a bottom view of an embodiment of the disclosure.

FIG. 3 is an exploded perspective view of an embodiment of the disclosure.

FIG. 4 is a right side exploded view of an embodiment of the disclosure.

FIG. 5 is a phantom in-use view of an embodiment of the disclosure.

### DETAILED DESCRIPTION OF THE INVENTION

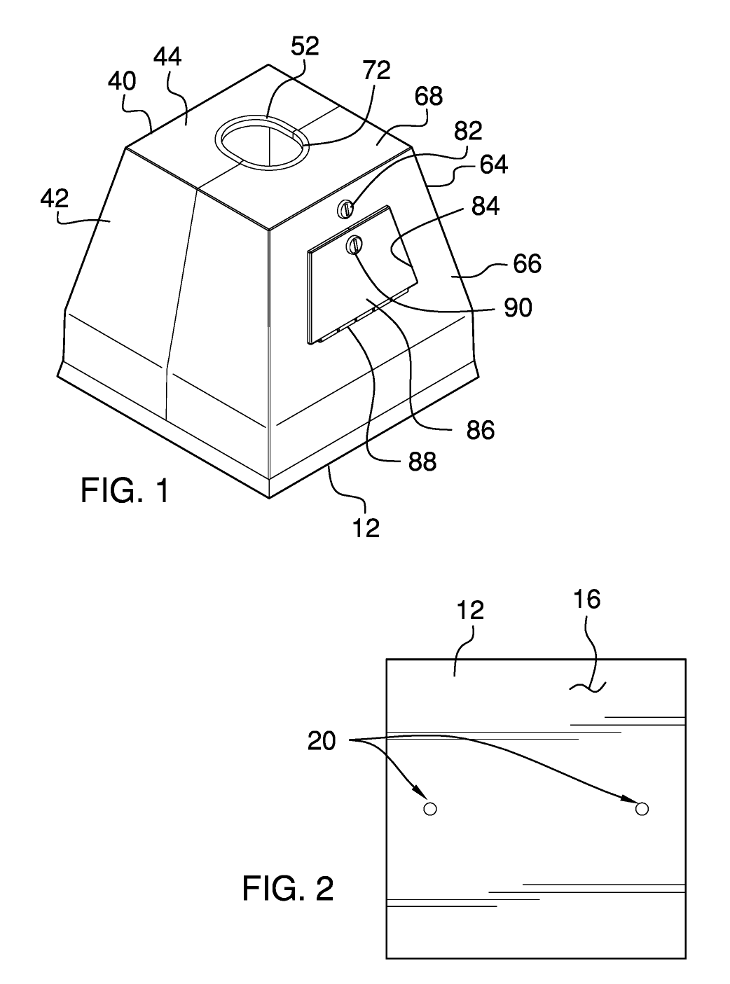

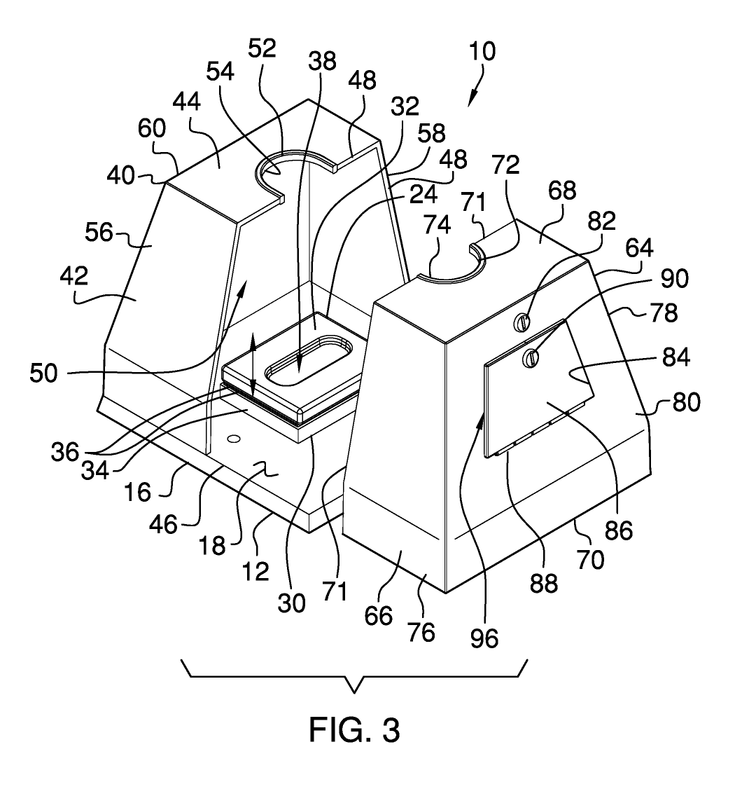

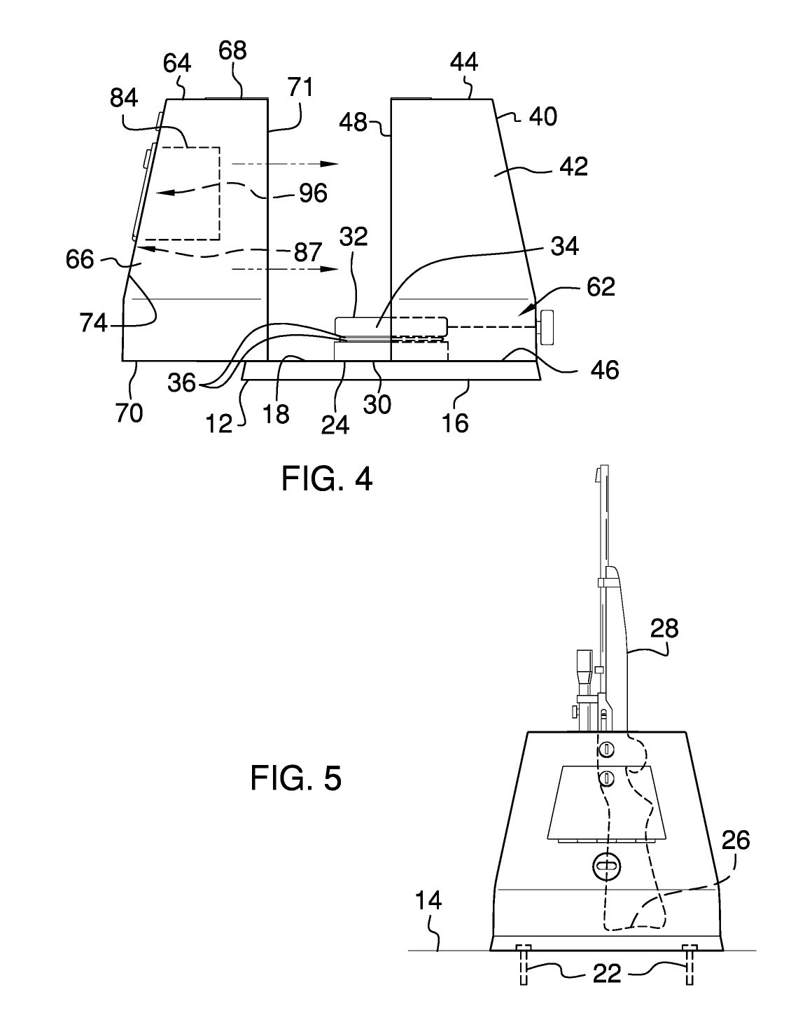

With reference now to the drawings, and in particular to FIGS. 1 through 5 thereof, a new safe device embodying the principles and concepts of an embodiment of the disclosure and generally designated by the reference numeral 10 will be described.

As best illustrated in FIGS. 1 through 5, the gun safe assembly 10 generally comprises a base 12 that is positioned on a support surface 14 such as a floor or the like. The base 12 has a first surface 16 and a second surface 18 and the base 12 has a plurality of apertures 20 extending through the first 16 and second 18 surfaces. The first surface 16 abuts the support surface 14 when the base 12 is positioned on the support surface 14. A plurality of fasteners 22 is provided and each of the fasteners 22 is selectively extended through an associated one of the apertures 20. Each of the fasteners 22 engages the support surface 14 thereby fastening the base 12 to the support surface 14. Moreover, each of the fasteners 22 may be a bolt or the like.

A platform 24 is positioned on the base 12 and a butt 26 of a rifle 28 is selectively positioned thereon having the rifle 28 being vertically oriented. The platform 24 has a bottom side 30, a top side 32 and a perimeter wall 34 extending therebetween. The perimeter wall 34 has a plurality of pleats 36 and the pleats 36 are spaced apart from each other and are distributed between the top side 32 and the bottom side 30. Thus, the top side 32 is selectively positioned a selected distance from the bottom side 30. The top side 32 has a well 38 extending toward the bottom side 30 and the well 38 is longitudinally elongated such that the well 38 has an ovoid shape. Thus, the well 38 may receive the butt 26 of the rifle 28. The bottom side 30 is coupled to the second surface 18 of the base 12 and the platform 24 is centrally positioned on the base 12.

A first shell 40 extends upwardly from the base 12 and the first shell 40 partially surrounds the rifle 28 when the rifle 28 is positioned on the platform 24. The first shell 40 has an outer wall 42 and an upper wall 44 that is spaced from the second surface 18 of the base 12. The outer wall 42 is aligned with a perimeter edge 46 of the base 12 and each of the outer wall 42 and the upper wall 44 has a first edge 48 defining an opening 50 into the first shell 40. The first edge 48 of the outer wall 42 intersects the first edge 48 of the upper wall 44 and the first edge 48 corresponding to each of the outer 42 and upper 44 walls is aligned with a center line of the base 12.

The upper wall 44 has a first slot 52 extending from the first edge 48 of the upper wall 44 toward the outer wall 42. The first slot 52 surrounds the rifle 28 when the rifle 28 is positioned on the platform 24. The first slot 52 has a bounding edge 54 and the bounding edge 54 is concavely arcuate such that the first slot 52 has a semi-ovoid shape. The outer wall 42 has a first lateral side 56, a second lateral side 58 and a back side 60. Each of the first lateral 56, the second lateral 58 and the back 60 sides intersect each other at a right angle. Moreover, the outer wall 42 angles inwardly between the base 12 and the upper wall 44 such that the first shell 40 defines a bisected trapezoid.

An actuator 62 is provided and the actuator 62 is movably coupled between the first shell 40 and the platform 24. The actuator 62 urges the top side 32 of the platform 24 away from the bottom side 30 of the platform 24 when the actuator 62 is manipulated in a lifting direction. The actuator 62 urges the top side 32 of the platform 24 toward the bottom side 30 of the platform 24 when the actuator 62 is manipulated in a lowering direction. Moreover, the actuator 62 is manipulated to align a scope on the rifle 28 with the first slot 52.

The actuator 62 may include a knob that is rotatably coupled to the outer wall 42 of the first shell 40. A rod may be coupled to the knob and the rod may extend into the platform 24. Additionally, the rod may engage a gear in the platform 24 such that the rod rotates the gear when the knob is manipulated. In this way the knob may lower and raise the top side 32 of the platform 24. Additionally, the actuator 62 may be an electrical actuator, a hydraulic actuator and any other mechanical actuator for lifting and lowering the platform 24.

A second shell 64 is removably coupled to the base 12 and the second shell 64 abuts the first shell 40. Each of the first 40 and second 64 shells surrounds the rifle 28 when the rifle 28 is positioned in the platform 24. The second shell 64 has an outermost wall 66 and an uppermost wall 68 and the outermost wall 66 has a distal edge 70 with respect to the uppermost wall 68. The distal edge 70 abuts the second surface 18 of the base 12 when the second shell 64 is positioned on the base 12. Moreover, the distal edge 70 is aligned with the perimeter edge 46 of the base 12.

Each of the outermost 66 and uppermost 68 walls has a primary edge 71 and the primary edge 71 of the outermost wall 66 intersects the primary edge 71 of the uppermost wall 68 to define an opening 72 into the second shell 64. The uppermost wall 68 has a second slot 72 extending from the primary edge 71 of the uppermost wall 68 toward the outermost wall 66. The second slot 72 has a bounding edge 74 and the bounding edge 74 of the second slot 72 is convavely arcuate such that the second slot 72 has a semi-ovoid shape.

The outermost wall 66 has a first outward side 76, a second outward side 78 and a front side 80. Each of the first outward side 76 and the second outward side 78 intersects the front side 80 at a right angle. The outermost wall 66 angles inwardly between the distal edge and the uppermost wall 68 such that the second shell 64 defines a bisected trapezoid. The primary edge 71 abuts the first edge 48 of the first shell 40 when the second shell 64 is positioned on the base 12.

The second slot 72 is aligned with the first slot 52 when the first shell 40 is positioned on the base 12. Each of the first 52 and second 72 slots forms an oval when the first shell 40 is positioned on the base 12 to accommodate the rifle 28 and a scope on the rifle. Each of the first 40 and second 64 shells inhibits the rifle 28 from being removed from the platform 24. The outermost wall 66 has an inside surface 74 and the outermost wall 66 has a hole 76 extending therethrough.

A first lock 82 is movably coupled to the second shell 64 and the first lock 82 is selectively manipulated. The first lock 82 engages the first shell 40 when the second shell 64 is positioned on the base 12. In this way the first lock 82 inhibits the rifle 28 from being removed from the base 12. The first lock 82 may be a keyed lock or the like and the first lock 82 may engage the first shell 40 through any conventional mechanical means.

A box 84 is coupled to the second shell 64 and the box 84 may contain objects for storage. The box 84 is positioned on the inside surface 74 of the outermost wall 66 and the box 84 is aligned with the hole 76 to access an interior of the box 84. A door 86 is hingedly coupled to the second shell 64 and the door 86 is aligned with the hole 76 such that the door 86 selectively opens and closes the box 84. The door 86 has a lower edge 88 and the lower edge 88 is hingedly coupled to the outermost wall 66 of the second shell 64.

A second lock 90 is coupled to the door 86 and the second lock 90 is selectively manipulated. The second lock 90 engages the outermost wall 66 of the second shell 64 when the door 86 is closed to restrict access to the box 84. The second lock 90 may be a keyed lock or the like and the second lock 90 may engage the second shell 64 through any conventional mechanical means. A pair of cushions may be provided and each of the cushions may be coupled to the bounding edge 54,74 of an associated one of the first 52 and second 72 slots.

In use, the butt 26 of the rifle 28 is positioned in the well 38 on the platform 24 and the second shell 64 is positioned on the base 12. Thus, each of the first 40 and second 64 shells surrounds the rifle 28 having the rifle 28 extending upwardly through the first 52 and second 72 slots. The first lock 82 is manipulated to lock the second shell 64 to the first shell 40 thereby securing the rifle 28. The knob is manipulated to selectively lower and raise the platform 24. The platform 24 is positioned to align the scope with the first 52 and second 72 slots and to position a trigger guard on the rifle 28 beneath uppermost wall 68 of the first shell 40. Thus, the trigger guard engages the uppermost wall 68 of the first shell 40 if a person attempts to urge the rifle 28 upwardly out of the first 52 and second 72 slots. In this way the rifle 28 is inhibited from being removed from the first 40 and second 64 shells. Additionally, the door 86 is selectively opened to place the objects in the box 84 and the second lock 90 is selectively manipulated to lock the door 86.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A gun safe assembly being configured to store a single rifle in a vertical orientation, said assembly comprising:
a base being configured to be positioned on a support surface;
a platform being positioned on said base wherein said platform is configured to have a butt of a rifle positioned thereon having the rifle being vertically oriented, said platform having a bottom side, a top side and a perimeter wall extending therebetween, said perimeter wall having a plurality of pleats, said pleats being spaced apart from each other and being distributed between said top side and said bottom side such that said top side is selectively positioned a selected distance from said bottom side;
a first shell extending upwardly from said base wherein said first shell is configured to partially surround the rifle when the rifle is positioned on said platform; and
a second shell being removably coupled to said base such that said second shell abuts said first shell wherein each of said first and second shells are configured to surround the rifle.

2. The assembly according to claim 1, wherein said base has a first surface and a second surface, said base having a plurality of apertures extending through said first and second surfaces, said first surface being configured for abutting the support surface.

3. The assembly according to claim 2, further comprising a plurality of fasteners, each of said fasteners being selectively extended through an associated one of said apertures wherein each of said fasteners is configured to engage the support surface thereby fastening said base to the support surface.

4. (canceled)

5. The assembly according to claim 1, wherein said top side has a well extending toward said bottom side, said well being longitudinally elongated such that said well has an ovoid shape wherein said well is configured to receive the butt of the rifle, said bottom side being coupled to a second surface of said base, said platform being centrally positioned on said base.

6. A gun safe assembly being configured to store a single rifle in a vertical orientation, said assembly comprising:
a base being configured to be positioned on a support surface, said base having a first surface and a second surface, said base having a plurality of apertures extending through said first and second surfaces, said first surface being configured for abutting the support surface;
a platform being positioned on said base wherein said platform is configured to have a butt of a rifle positioned thereon having the rifle being vertically oriented;
a first shell extending upwardly from said base wherein said first shell is configured to partially surround the rifle when the rifle is positioned on said platform;
a second shell being removably coupled to said base such that said second shell abuts said first shell wherein each of said first and second shells are configured to surround the rifle; and
wherein said first shell has an outer wall and an upper wall being spaced from said second surface of said base, said outer wall being aligned with a perimeter edge of said base, each of said outer wall and said upper wall having a first edge defining an opening into said first shell, said first edge of said outer wall intersecting said first edge of said upper wall, said first edge corresponding to each of said outer and upper walls being aligned with a center line of said base.

7. The assembly according to claim 6, wherein said upper wall has a first slot extending from said first edge of said upper wall toward said outer wall wherein said first slot is configured to surround the rifle when the rifle is positioned on said platform, said first slot having a bounding edge, said bounding edge being concavely arcuate such that said first slot has a semi-ovoid shape.

8. The assembly according to claim 6, wherein said outer wall has a first lateral side, a second lateral side and a back side, each of said first lateral, said second lateral and said back sides intersecting each other at a right angle, said outer wall angling inwardly between said base and said upper wall such that said first shell defines a bisected trapezoid.

9. The assembly according to claim 1, further comprising an actuator being movably coupled between said first shell and said platform wherein said actuator is configured to be manipulated, said actuator urging said top side of said platform away from said bottom side of said platform when said actuator is manipulated in a lifting direction, said actuator urging said top side of said platform toward said bottom side of said platform when said actuator is manipulated in a lowering direction.

10. A gun safe assembly being configured to store a single rifle in a vertical orientation, said assembly comprising:
a base being configured to be positioned on a support surface, said base having a first surface and a second surface, said base having a plurality of apertures extending through said first and second surfaces, said first surface being configured for abutting the support surface;
a platform being positioned on said base wherein said platform is configured to have a butt of a rifle positioned thereon having the rifle being vertically oriented;
a first shell extending upwardly from said base wherein said first shell is configured to partially surround the rifle when the rifle is positioned on said platform;
a second shell being removably coupled to said base such that said second shell abuts said first shell wherein each of said first and second shells are configured to surround the rifle; and
wherein said second shell has an outermost wall and an uppermost wall, said outermost wall having a distal edge with respect to said uppermost wall, said distal edge abutting said second surface of said base when said second shell is positioned on said base having said distal edge being aligned with a perimeter edge of said base, each of said outermost and uppermost walls having a primary edge, said primary edge of said outermost wall intersecting said primary edge of said uppermost wall to define an opening into said second shell.

11. The assembly according to claim 10, wherein said uppermost wall has a second slot extending from said primary edge of said uppermost wall toward said outermost wall, said second slot having a bounding edge, said bounding edge of said second slot being convavely arcuate such that said second slot has a semi-ovoid shape.

12. The assembly according to claim 11, wherein said outermost wall has a first outward side, a second outward side and a front side, each of said first outward side and said second outward side intersecting said front side at a right angle, said outermost wall angling inwardly between said distal edge and said uppermost wall such that said second shell defines a bisected trapezoid.

13. The assembly according to claim 12, wherein:
said first shell has a first edge and a first slot; and
said primary edge of said outermost wall and said uppermost wall abuts said first edge of said first shell when said second shell is positioned on said base having said second slot being aligned with said first slot wherein each of said first and second shells are configured to inhibit the rifle from being removed from said platform.

14. The assembly according to claim 10, further comprising a first lock being movably coupled to said second shell wherein said first lock is configured to be manipulated, said first lock engaging said first shell when said second shell is positioned on said base wherein said first lock is configured to inhibit the rifle from being removed from said base.

15. The assembly according to claim 10, further comprising:
said outermost wall having an inside surface, said outermost wall having a hole extending therethrough; and
a box being coupled to said second shell wherein said box is configured to contain objects for storage, said box being positioned on said inside surface of said outermost wall, said box being aligned with said hole to access an interior of said box.

16. The assembly according to claim 15, further comprising a door being hingedly coupled to said second shell, said door being aligned with said hole such that said door selectively opens and closes said box, said door having a lower edge, said lower edge being hingedly coupled to said outermost wall of said second shell.

17. The assembly according to claim 16, further comprising a second lock being coupled to said door wherein said second lock is configured to be manipulated, said second lock engaging said outermost wall of said second shell when said door is closed to restrict access to said box.

18. The assembly of claim 1, further comprising:
said base having a first surface and a second surface, said base having a plurality of apertures extending through said first and second surfaces, said first surface being configured for abutting the support surface;
a plurality of fasteners, each of said fasteners being selectively extended through an associated one of said apertures wherein each of said fasteners is configured to engage the support surface thereby fastening said base to the support surface;
said top side having a well extending toward said bottom side, said well being longitudinally elongated such that said well has an ovoid shape wherein said well is configured to receive the butt of the rifle, said bottom side being coupled to said second surface of said base, said platform being centrally positioned on said base;
said first shell having an outer wall and an upper wall being spaced from said second surface of said base, said outer wall being aligned with a perimeter edge of said base, each of said outer wall and said upper wall having a first edge defining an opening into said first shell, said first edge of said outer wall intersecting said first edge of said upper wall, said first edge corresponding to each of said outer and upper walls being aligned with a center line of said base, said upper wall having a first slot extending from said first edge of said upper wall toward said outer wall wherein said first slot is configured to surround the rifle when the rifle is positioned on said platform, said first slot having a bounding edge, said bounding edge being concavely arcuate such that said first slot has a semi-ovoid shape, said outer wall having a first lateral side, a second lateral side and a back side, each of said first lateral, said second lateral and said back sides intersecting each other at a right angle, said outer wall angling inwardly between said base and said upper wall such that said first shell defines a bisected trapezoid;
an actuator being movably coupled between said first shell and said platform wherein said actuator is configured to be manipulated, said actuator urging said top side of said platform away from said bottom side of said platform when said actuator is manipulated in a lifting direction, said actuator urging said top side of said platform toward said bottom side of said platform when said actuator is manipulated in a lowering direction, said actuator being configured to align a scope on the rifle with said first slot;
said second shell having an outermost wall and an uppermost wall, said outermost wall having a distal edge with respect to said uppermost wall, said distal edge abutting said second surface of said base when said second shell is positioned on said base having said distal edge being aligned with said perimeter edge of said base, each of said outermost and uppermost walls having a primary edge, said primary edge of said outermost wall intersecting said primary edge of said uppermost wall to define an opening into said second shell, said uppermost wall having a second slot extending from said primary edge of said uppermost wall toward said outermost wall, said second slot having a bounding edge, said bounding edge of said second slot being convavely arcuate such that said second slot has a semi-ovoid shape, said outermost wall having a first outward side, a second outward side and a front side, each of said first outward side and said second outward side intersecting said front side at a right angle, said outermost wall angling inwardly between said distal edge and said uppermost wall such that said second shell defines a bisected trapezoid, said primary edge of said outermost wall and said uppermost wall abutting said first edge of said outer wall and said upper wall of said first shell when said second shell is positioned on said base having said second slot being aligned with said first slot wherein each of said first and second shells are configured to inhibit the rifle from being removed from said platform, said outermost wall having an inside surface, said outermost wall having a hole extending therethrough;
a first lock being movably coupled to said second shell wherein said first lock is configured to be manipulated, said first lock engaging said first shell when said second shell is positioned on said base wherein said first lock is configured to inhibit the rifle from being removed from said base;
a box being coupled to said second shell wherein said box is configured to contain objects for storage, said box being positioned on said inside surface of said outermost wall, said box being aligned with said hole to access an interior of said box;
a door being hingedly coupled to said second shell, said door being aligned with said hole such that said door selectively opens and closes said box, said door having a lower edge, said lower edge being hingedly coupled to said outermost wall of said second shell; and
a second lock being coupled to said door wherein said second lock is configured to be manipulated, said second lock engaging said outermost wall of said second shell when said door is closed to restrict access to said box.
